(19) United States
(12) Patent Application Publication
(10) Pub. No.: US 2009/0037204 A1
(43) Pub. Date: Feb. 5, 2009

(54) METHOD FOR PROVIDING PRODUCT SAFETY TO A MANUFACTURED ITEM USING A MULTIPLE USE VERIFICATION CODE

(75) Inventor: Cheng Tan, Cupertino, CA (US)

Correspondence Address: STRATEGIC PATENT GROUP, P.C., P.O. BOX 1329, MOUNTAIN VIEW, CA, 94042, US

(73) Assignee: MOXIE PROXY, Cupertino, CA (US)

(21) Appl. No.: 11/833,654

(22) Filed: Aug. 3, 2007

(51) Int. Cl. G06Q 99/00

(52) U.S. Cl. 705/1

(57) ABSTRACT

In a method and system for providing product safety to a manufactured item, a verification code is associated with the manufactured item. The verification code is initialized to an unvalidated state. The manufactured item is then supplied with this verification code hidden from view. The verification code may be exposed by a user and submitted to a validation service for validation for any number of occasions. In response to the validation service receiving the verification code for validation, the user is provided with an indicator of a current state of the verification code. A first successful validation of the verification code is then used as an event that triggers a state transition of the verification code from the unvalidated state to a validated state.

### BACKGROUND OF THE INVENTION

After manufactured items are released to the distribution chain for sale, threats to product safety include product relabeling, label tampering, intermingling with counterfeits, discovery of problems that warrant actions such as advisories and recalls, and product lifetime expiry. An example of tampering was the discovery in 2003 of relabeled vials of the anemia medication PROCRIT®. The vials were 2,000 units/mL that had expired, and were relabeled to state 40,000 units/mL, raising the retail price from $25 per vial to $750 per vial. Twenty-five thousand patients were administered the potentially dangerous and weaker doses from the relabeled vials, and investigators found that up to 110,000 vials were compromised.

It is desirable to provide means for users to check on the viability or validity of items. Serial and batch numbers, product expiry dates, and other visible indicia alone are insufficient protection because these can be tampered with or relabeled. A counterfeiter could also mass produce copies of an item, all having valid or manipulated indicia.

### BRIEF SUMMARY OF THE INVENTION

The present invention provides a method and system for providing product safety to a manufactured item, where a verification code is associated with the manufactured item. The verification code is initialized to an unvalidated state. The manufactured item is then supplied with this verification code hidden from view. The verification code may be exposed by a user and submitted to a validation service for validation for any number of occasions. In response to the validation service receiving the verification code for validation, the user is provided with an indicator of a current state of the verification code. A first successful validation of the verification code is then used as an event that triggers a state transition of the verification code from the unvalidated state to a validated state.

According to the method and system disclosed herein, manufactured items are protected by assigning a unique verification code that is low-cost, easy to manage, and easy to use. The manufacturer does not need to make any claims with regards to authenticity of the protected item, and it is sufficient that the manufacturer advertises that these verification codes provide up-to-date information. Validation of the verification codes can be done easily without the need for any specialized scanners or hardware.

### BRIEF DESCRIPTION OF SEVERAL VIEWS OF THE DRAWINGS

FIG. 1 shows a flow diagram for an exemplary embodiment.

FIGS. 2A-C show state diagrams for different verification codes.

FIGS. 3A-C show how verification codes may be placed and hidden.

FIG. 4A shows two exemplary avenues for validation.

FIG. 4B shows an example of a web user interface that may be used for validation.

FIG. 5 shows an example of validation processing steps.

FIG. 6 shows exemplary messages that can be returned to the user for different verification code states.

FIGS. 7A-C show examples of database table schemas for tracking and using the verification codes.

### DETAILED DESCRIPTION OF THE INVENTION

The present invention relates to providing product safety to manufactured items. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention is mainly described in terms of particular systems provided in particular implementations. However, one of ordinary skill in the art will readily recognize that this method and system will operate effectively in other implementations. For example, the systems, devices, and networks usable with the present invention can take a number of different forms. The present invention will also be described in the context of particular methods having certain steps. However, the method and system operate effectively for other methods having different and/or additional steps not inconsistent with the present invention.

The present invention provides a method and system for providing product safety to a manufactured item using a multiple use verification code. Product relabeling, label tampering, counterfeiting, and other product safety threats are countered by providing a substantially unique verification code with each manufactured item, transitioning the state of the verification code on key events, allowing a user to check on the state of the verification code, and in one embodiment, obtain additional information about the item.

For the user, validation of the verification codes is easy and it does not require any specialized scanners or hardware. A protected item that is sold without a verification code, or has a verification code that does not validate correctly will raise a flag, and the item can be rejected or returned.

The manufacturer gains protection from product relabeling, label tampering, and counterfeiting, and they also have an avenue to disseminate information about the item after it has been released or sold. Any manufactured item can be protected with this method.

Provisioning and Use

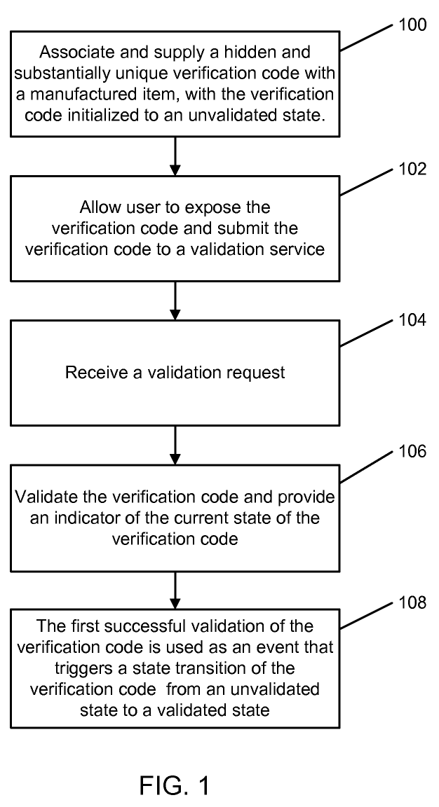

FIG. 1 is a flowchart of an embodiment of a method for providing product safety to a manufactured item using a multiple-use verification code. The process begins with an entity, such as a manufacturer, a provisioning service, or a validation service associating a substantially unique verification code with a manufactured item. The manufactured item is supplied, e.g., sold, with the verification code hidden from view, with the verification code initialized to an initial state (block 100). In the exemplary embodiment, the verification code may be initialized to an unvalidated state. Hiding of the verification code may be achieved by enclosing the verification code together with the item within sealed and opaque packaging, or it may be placed within a sealed container such as an envelope that is attached to the manufactured item. The verification code may also be hidden by obscuring the code behind scratch-removable material.

Each verification code has an associated state that is maintained by an entity, such as the manufacturer or a validation service, and this state may be stored in a database. According to the exemplary embodiment, as stated above, the verification code is initialized to an unvalidated state, but in other embodiments, but the initial state may be associated with any name or identifier, such as unconfirmed or unverified, for instance.

A consumer who takes possession of the item (e.g. after buying it, or before using or consuming it), exposes the verification code, and submits the verification code to a validation service for any number of occasions (block 102). In response to the validation service receiving the verification code for validation (block 104), the verification service validates the verification code, and the user is provided with an indicator (e.g. a displayed message) of the current state of the verification code (block 106). The first successful validation of the verification code is used as an event that triggers a state transition of the verification code from the unvalidated state to a second state, such as a validated state (block 108). In other embodiments, the verification code may be transitioned to any other type of second state, such as a confirmed or a verified state, for instance. Blocks 106 and 108 are not necessarily order dependent, as the indicator of the state may be provided after a state transition, as explained below.

The state transition from the unvalidated state to the validated state serves as an anti-counterfeiting measure. With the first validation and state transition from the initial state to the validated state, an indicator such as a message may be provided to the user indicating that the verification code is valid and that it is the first validation. Thereafter, validations performed while the validation code is in the validated state may result in messages indicating that the verification code is valid and that it has been previously validated. Counterfeiters will be thwarted by the inability to mass produce items with verification codes that will validate correctly since the codes must be valid as well as be in the expected state.

While not shown in FIG. 1, other significant events may transition a verification code's state to different or additional states. If a problem with the product is discovered, the state of the verification code may be changed so that appropriate indicators can be provided to the user on validation. Examples of other states include advise (to provide a product advisory), recall (to issue a product recall), expired (to coincide with product expiry), and invalid.

Verification Code States

The validation service may transition a verification code to a new state during a validation request, such as with the first successful validation as discussed with FIG. 1, or on discovery of problems such as when a product safety issue arises that warrants an advisory or recall.

Multiple-Use Verification Codes

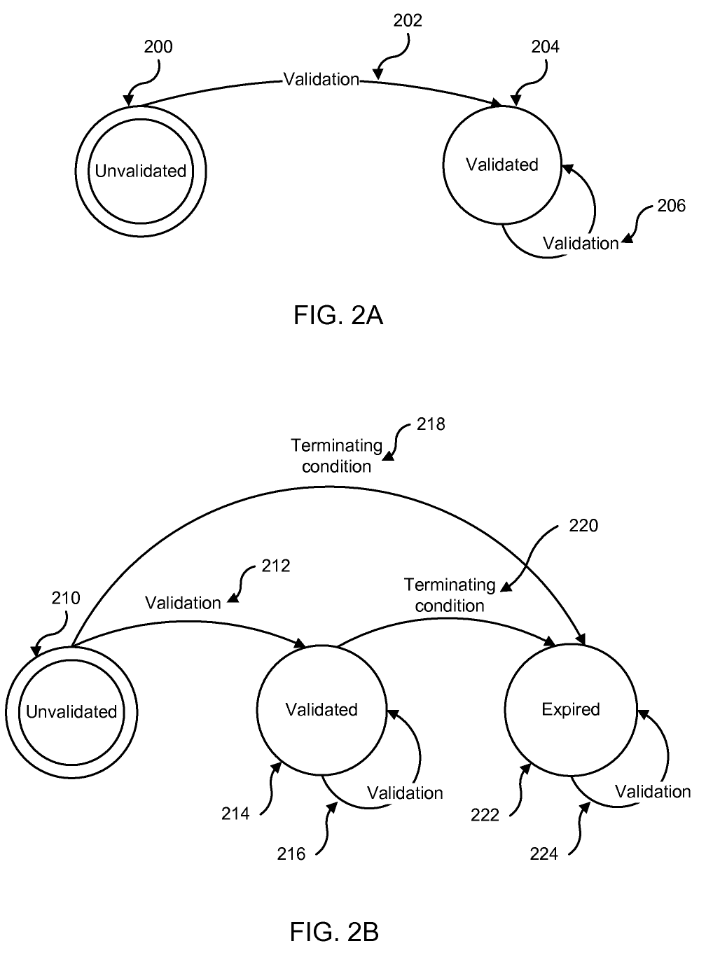

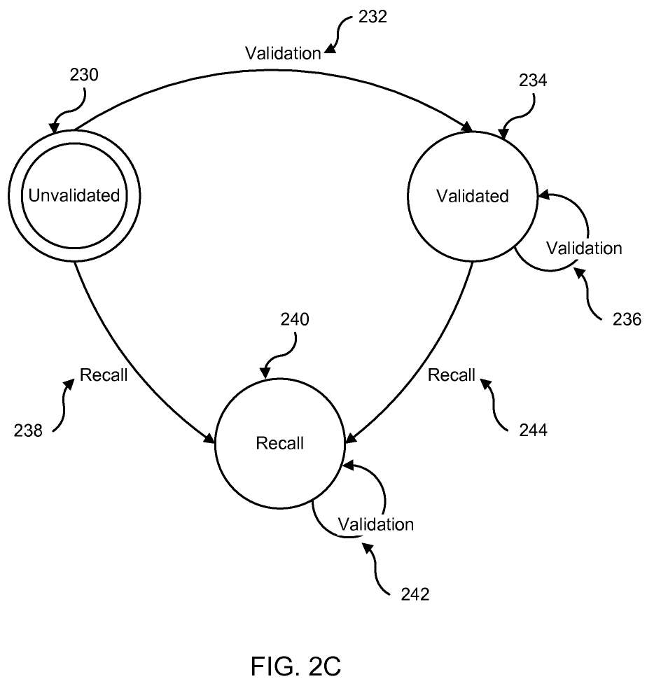

FIG. 2A shows how a set of states may be used to create a verification code that may be validated for any number of occasions. In this embodiment, a verification code starts out in an unvalidated state 200. On the first successful validation 202, the verification code is transitioned to a validated state 204, where subsequent validations 206 are processed and the verification code remains in the validated state 204. In response to a successful validation 202, the validation service will indicate that the verification code is valid and that it is the first validation. For validations 206, the validation service will indicate that the verification code is valid and that it has been previously validated. A multiple-use verification code is thus implemented.

Additional State Transitions

FIG. 2B shows how a different set of states may be used to create an expiring verification code. In this embodiment, a verification code starts out in an unvalidated state 210. On the first successful validation 212, the verification code is transitioned to a validated state 214, where subsequent validations 216 are processed and the verification code remains in the validated state 214. A terminating condition 218 and another terminating condition 220, such as product expiry, may transition the verification code to an expired state 222. Terminating condition 218 and terminating condition 220 do not have to be the same. In the expired state 222, validations 224 are processed and the verification code remains in the expired state 222. For validations 224, the validation service will provide the indicator for the verification code in the expired state.

Transitioning on Time and Number of Validations

In FIG. 2B, different types of verification codes are created by the choice of terminating conditions 218 and 220. One type of time-limited verification code is created if terminating condition 218 is eliminated and terminating condition 220 occurs after a fixed period of time from entry into the validated state 214.

A different type of time-limited verification code may have the terminating conditions 218 and 220 occurring when a fixed time is reached. Such a time-limited verification code may be useful for consumables such as pharmaceuticals where the product expires at a fixed time from when the product was manufactured.

A count-limited verification code is created if terminating condition 218 is eliminated and terminating condition 220 occurs after a fixed number of validations 216 have been performed in the validated state 214. Count-limited verification codes may be useful for situations where there are well-defined workflows that have validations occurring at fixed junctures.

Incorporating a Recall State

FIG. 2C shows a state diagram of a verification code with a recall state incorporated. In this embodiment, a verification code starts out in an unvalidated state 230. On the first successful validation 232, the verification code's state is transitioned to a validated state 234 where validations 236 are processed without any change in the verification code's state.

If the item is discovered to be compromised before its verification code has been validated, a recall event 238 will transition the verification code to a recall state 240 where validations 242 will be processed without any change in verification code state. For validations 242, the validation service will indicate that a recall for the item is in effect, and the embodiment can provide further instructions.

If the item is discovered to be compromised after its verification code has been validated, a recall event 244 will transition the verification code to the recall state 240 where validations 242 will be processed without any change in verification code state.

Although FIGS. 2B and 2C show that the unvalidated state 210 and 230 and the validated state 214 and 234 may both transition to an expired state 222 and a recall state 240, it should be understood that the unvalidated state 210 and 230 and the validated state 214 and 234 may also transition to any other types of states, such as advise and invalid, for instance.

Manufacturers can decide on the state transitions allowed and the type of verification code that is appropriate for their needs.

Generation of Verification Codes

There are numerous methods for generating verification codes. A lengthy code will be an impediment to undesired guessing, yet the code needs to be short enough for a user to submit. Ten to twenty characters may be acceptable. The codes should not be in any predictable order, and they should ideally be scattered throughout the range of the code generation functions. Hash functions such as the Secure Hash Algorithm (SHA) family of functions, and encryption functions such as Data Encryption Standard (DES) and 3DES may be used, separately or in combination.

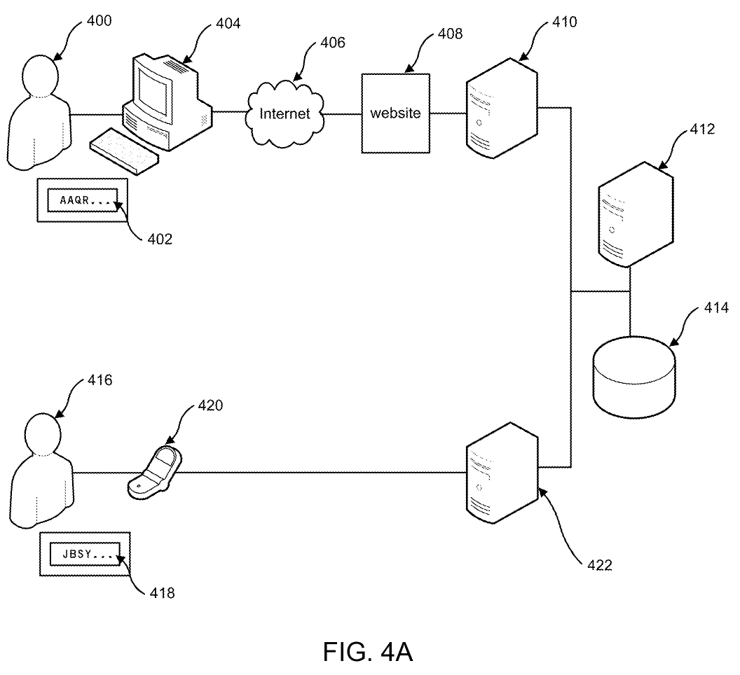

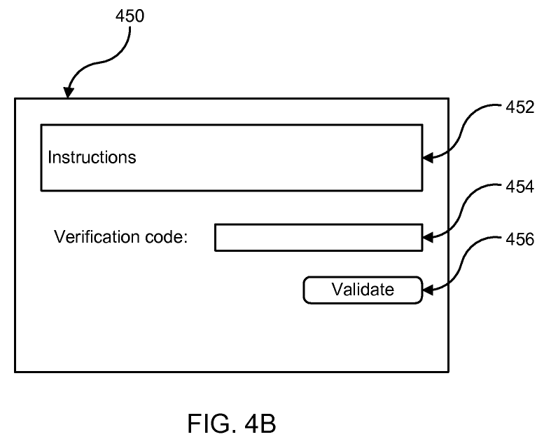

To increase the density of the information packed into the verification code, binary output can be represented in base 36 for a case-insensitive alphanumeric numeral system (A-Z and 0-9), or base 64 (A-Z, a-z, 0-9+2 additional characters) for a case-sensitive system. Base 36 or lower is suggested if telephone validation (discussed with FIG. 4A below) is expected.

A verification code may also be encoded as a barcode. This may be a convenient option if the validation service is capable of barcode processing and users are allowed to send in images of the barcode, or if users have access to barcode readers.

To aid validity checks and to thwart guessing, encrypted codes of known information may be injected into the verification code for decryption and comparison during validation. Checksums and parity bits may also be injected for this purpose.

Supplying the Verification Code with the Manufactured Item

Hiding the verification code can be achieved by placing the code with the item and enclosing both in opaque packaging. If the code is to be attached externally, it can be placed within a sealed envelope, or it can be covered with opaque and tamper-evident material.

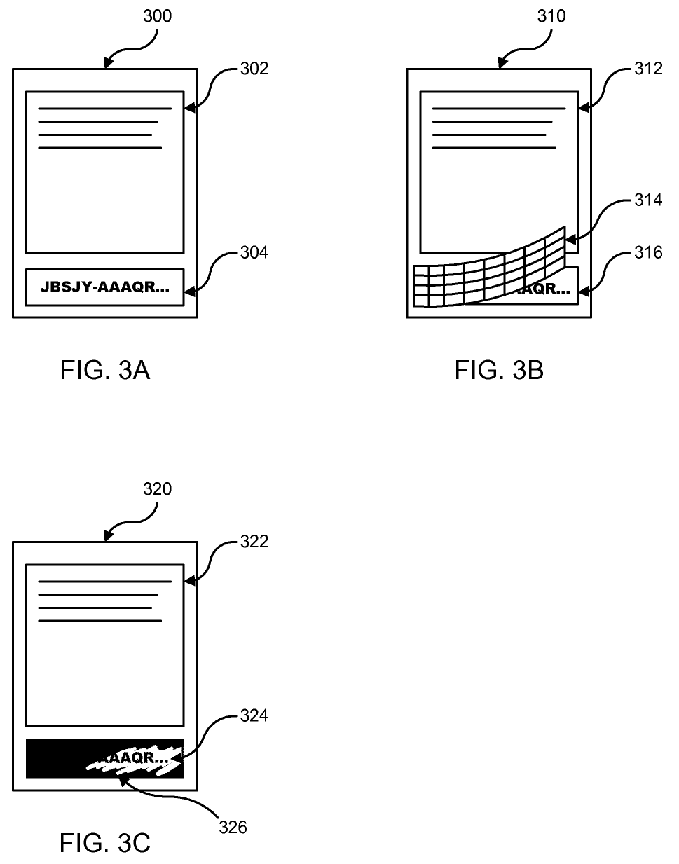

FIG. 3A, 3B and 3C show examples of cards with verification codes and how the codes may be hidden. FIG. 3A shows a card 300 with validation instructions 302 and verification code 304. Because the verification code 304 is visible, card 300 is suitable for placement within a factory sealed box, or within a sealed envelope that is supplied with the item.

FIG. 3B shows a different example of a card 310 with validation instructions 312 and verification code 316 hidden behind an opaque and tamper-evident tape 314 (shown partially lifted). Card 310 can be used as a tag that is supplied with the item.

FIG. 3C shows another example of a card 320 with validation instructions 322 and verification code 324 hidden behind scratch-removable material 326 (shown partially removed). Card 320 can be used as a tag that is supplied with the item.

As used herein, the term manufactured item includes any type of article or device that is made or manufactured. The term can also apply to containers that may be used for shipping the one or more manufactured items, for example. In such an embodiment, a verification code may be used to protect the contents of the container.

Submitting a Validation Request

Validation takes place with a user submitting the verification code to a validation service. FIGS. 4A and 4B are diagrams illustrating exemplary embodiments.

FIG. 4A shows two exemplary avenues that can be provided to allow users to validate verification codes.

In one embodiment, a user 400, who wishes to check on verification code 402 that was supplied with a protected item (not shown), may use a web browser on a computer 404 to navigate through the internet 406 to a validation section on a manufacturer's or a validation service's website 408. The user 400 then submits the verification code 402.

The web or application server 410 then performs a check with the validation system 412 to validate the provided verification code. Validation system 412 may use a database 414 as part of processing. The validation result is then returned to user 400 via a web page, for example.

In another embodiment, a user 416, who wants to check on verification code 418 that was supplied with an item (not shown), may use a phone 420 to place a call to the manufacturer or the validation service where an automated phone system 422 services the call. User 416 enters the verification code 418 when prompted, and the automated phone system 422 performs a check with the validation system 412 to validate the provided verification code. The validation result can then be read back to user 416, via audio.

While not shown, other possible avenues for validation may be implemented. These may include an interactive voice response system, a live representative, transmission of a photographic image such as a barcode, and data-interchange via specialized electronic devices.

FIG. 4B shows an example of a web page 450 with user interface elements for allowing a user to perform a validation. The web page 450 may include a text block 452, an input text box 454, and an input button 456. Text block 452 can give an introduction and instructions for reading the verification code. Input text box 454 is for the user to enter the verification code, and input button 456 is for the user to submit the validation request.

Processing a Validation Request

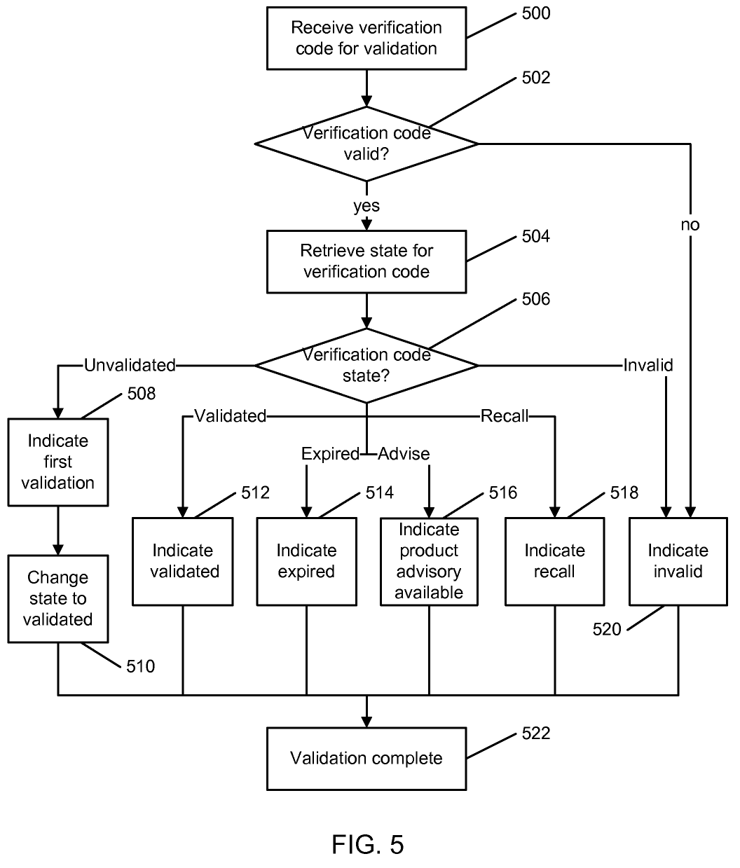

FIG. 5 is a flowchart that shows how a validation service in an embodiment may process a validation request. A validation request for a verification code is received (block 500). Checks are made to see that the verification code is valid (block 502). These checks may include seeing that the verification code is in the range of the verification code generation functions, that it passes all the format checks, if any, that were built in (e.g. checksum and parity bits), and that the verification code was previously provisioned (e.g. it was generated previously, associated with an item, and stored in the validation database). If it is invalid, an invalid code is indicated (block 520) and the validation completes (block 522). Otherwise, the state for the verification code is retrieved (block 504). This may be accomplished with a database lookup using the verification code as the key. An indication based on the verification code's state is then returned to the requester. If the state is unvalidated, an indicator that this is the first validation is returned (block 508) and the state is updated to validated (block 510). For the remaining states, an indicator corresponding to the state is returned (blocks 512 to 520). The validation then completes (block 522).

If appropriate, additional state transitions may also occur during processing of a validation request (not shown). For example, if an embodiment of FIG. 2B above implements a time-limited verification code, then processing of a validation while a verification code is in the unvalidated state 210 and validated state 214 may be preceded by a time check to see if the terminating condition 218 and 220 respectively has been met. If so, the verification code is transitioned to the expired state 222. Otherwise, the validation is processed as step 212 or 216 respectively.

Messages as Indicators for Different Verification Code States

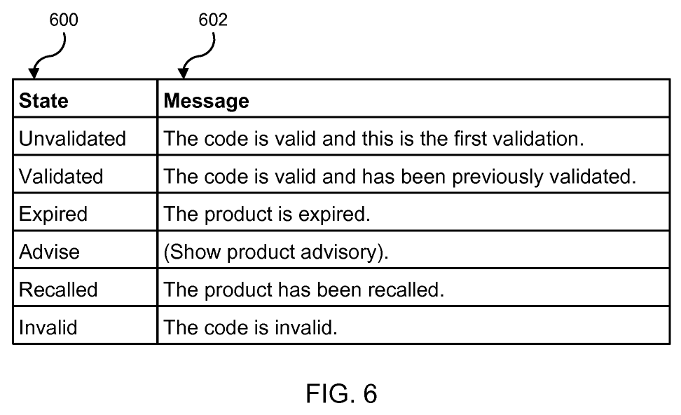

FIG. 6 is a table showing examples of messages that may be returned by the validation service in response to a validation request in an embodiment. For each verification code state listed in column 600, there is a corresponding message in column 602 that can be returned to the user.

State Maintenance and Tracking of Verification Codes

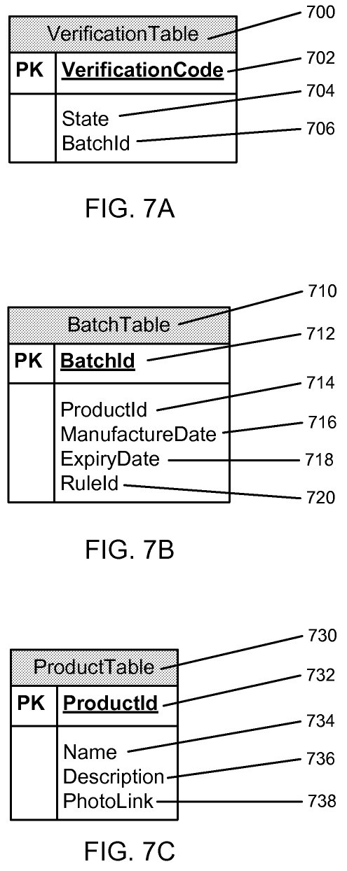

FIGS. 7A, 7B and 7C show examples of database table schemas that can be used to track the state of verification codes and to aid processing of validations.

FIG. 7A is a database table 700 that holds verification codes. Column VerificationCode 702 is the primary key. With a verification code, information about the verification code's state 704, and the batch identifier for the associated manufactured item 706 can be retrieved. Table 700 may also be used to store additional information that is unique to the verification code or unique to the associated manufactured item, such as the manufactured item's serial number (not shown).

Column State 704 may be an enumerated value of the present state of the verification code. Column BatchId 706 is a foreign key into a BatchTable 710 that provides information about the batch of items that the associated manufactured item belongs to.

FIG. 7B is a database table 710 that holds information about a batch of manufactured items. Column Batchld 712 is the primary key. With a batch identifier, information about the product 714, the date of manufacture 716, the expiry date 718, and the validation processing rule 720 can be retrieved. Table 710 may also be used to store additional information that is unique to the batch of manufactured items, such as supply or distribution chain identifiers (not shown).

Column ProductId 714 is a foreign key into a ProductTable 730 that provides information about the product that a batch of items belongs to.

For validation processing, column RuleId 720 may either be a key to a database entity that describes the processing rule and its parameters, or it may be an enumerated type for a rule that is external to the database. In an embodiment, a rule identifier can be an enumerated type that specifies the type of verification code as described with FIGS. 2A-C (e.g. multiple-use or time-limited) and the parameters that control the state transitions. The validation service is then able to conditionalize processing of a validation request on the type of verification code.

FIG. 7C is a database table 730 that provides information about a product. Column ProductId 732 is the primary key. With a product identifier, information about the product's name 734, the description 736, and the link to a photographic image 738 can be retrieved. Table 730 may also be used to store additional information that is unique to the product as well as product characteristics such as the model number, the model color, the list of ingredients, and the active ingredient concentrations.

Additional Information Indicated During Validation for Reinforcement

In addition to the state-dependent indicators that are provided to the user on validation (such as the messages described with FIG. 6), the manufacturer or validation service may choose, in an embodiment, to also provide information related to the manufactured item that is associated with the verification code for additional reinforcement, and to help guard against product relabeling and label tampering. This may be any combination of information that is unique to the manufactured item such as a serial number, information that is unique to a batch of items such as a batch number or expiry date, and information that may or may not be unique to the product such as the name and description, the model number, the model color, the ingredient list, or the active ingredient concentrations. Photographic images or drawings may be shown as well, and these too may or may not be unique to the manufactured item. By providing such information, users can confirm for themselves, and any discrepancies can be further investigated or reported, or they may be grounds for rejecting the item.

To achieve this, information that is unique to the manufactured item, such as a serial number, can be stored in the VerificationTable 700 to allow retrieval by verification code for subsequent display. Information that is unique to a batch of items, such as the batch number or expiry date, can be stored in the BatchTable 710, and other unique or non-unique information for the product can be stored in ProductTable 730.

Security—Validation Limits

Temporary validation blocks may be imposed on a user after some number of failed validation attempts. This would stop attempts to guess at verification codes.

Roles

It should not be taken as a limitation that the manufacturer is the entity that:

1. Generates the verification code.

2. Associates the verification code with the item.

3. Provides the validation service.

4. Maintains the state of the verification codes.

Where feasible, these different tasks and roles, in whole or in part, can be provided or undertaken by any entity. This may include representatives and agents of the manufacturer, and third parties.

A method and system for providing product safety to manufactured items have been disclosed. Product relabeling, label tampering, counterfeiting and other product safety threats are countered by providing a substantially unique verification code with each manufactured item, transitioning the state of the verification code on key events, allowing a user to check on the state of the verification code, and in one embodiment, obtain additional information about the item.

For the user, validation of the verification codes is easy and it does not require any specialized scanners or hardware. A protected item that is sold without a verification code, or has a verification code that does not validate correctly will raise a flag, and the item can be rejected or returned.

The manufacturer gains protection from product relabeling, label tampering and counterfeiting, and they also have an avenue to disseminate information about the item after it has been released or sold. Any manufactured item can be protected with this method.

The present invention has been described in accordance with the embodiments shown, and one of ordinary skill in the art will readily recognize that there could be variations to the embodiments, and any variations would be within the spirit and scope of the present invention. For example, the names associated with the various states and their transitions may be changed and still fall with the scope of the present invention. The present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A method for providing product safety to a manufactured item comprising:
supplying a verification code with the manufactured item, the verification code being hidden from view, wherein the verification code is initialized to an unvalidated state;
allowing a user to expose the verification code and to submit the verification code to a validation service a plurality of times;
in response to the validation service receiving the verification code for validation, providing the user with an indicator of a current state of the verification code; and
using a first successful validation of the verification code as an event that triggers a state transition of the verification code from the unvalidated state to a validated state.

2. The method of claim 1 wherein the unvalidated state of the verification code is transitioned to a third state after one of: a period of time from being initialized to the unvalidated state, a period of time up to a fixed time, and on discovery of a problem.

3. The method of claim 2 wherein the third state is one of: advise, recall, expired, and invalid.

4. The method of claim 1 wherein the validated state of the verification code is further transitioned to a third state after one of: a period of time from entry into the validated state, a period of time up to a fixed time, a fixed number of validations, and on discovery of a problem.

5. The method of claim 4 wherein the third state is one of: advise, recall, expired, and invalid.

6. The method of claim 1 wherein providing an indicator to the user in response to the validation of the verification code further comprises providing information that is any combination of being: unique to the manufactured item, unique to the batch of items that the manufactured item belongs to, and unique to the product.

7. The method of claim 1 wherein the verification code is hidden from view by one of: being placed within an opaque container, and being hidden behind opaque tamper-evident material.

8. The method of claim 1 wherein allowing the user to expose the verification code is by one of: after purchase, after taking possession, before use, and before consumption.

9. The method of claim 1 wherein receiving by a validation service a plurality of submissions of the verification code for validation is done through one of: a website, an automated phone system, an interactive voice-response system, a phone conversation with a person, transmission of a photographic image, and electronic data exchange.

10. A product protection system comprising:
a manufactured item;
a multiple use verification code, wherein
the multiple use verification code is hidden from view,
is initialized to an unvalidated state, and
exposed by a user; and
a validation system for validating the multiple use verification code by:
receiving the multiple use verification code, and
validating the multiple use verification code as a first validation and transitioning the state of the multiple use verification code from the unvalidated state to a validated state if the multiple use verification code is valid and received for the first time, and
validating the multiple use verification code as valid and having been previously validated if the multiple use verification code is valid and the state of the multiple use verification code is validated.

11. The system of claim 1 0 wherein the unvalidated state of the multiple use verification code is transitioned to a third state after one of: a period of time from being initialized to the unvalidated state, a period of time up to a fixed time, and on discovery of a problem.

12. The system of claim 11 wherein the third state is one of: advise, recall, expired, and invalid.

13. The system of claim 10 wherein the validated state of the multiple use verification code is further transitioned to a third state after one of: a period of time from entry into the validated state, a period of time up to a fixed time, a fixed number of validations, and on discovery of a problem.

14. The system of claim 13 wherein the third state is one of: advise, recall, expired, and invalid.

15. The system of claim 10 wherein the validation system upon validating the multiple use verification code further provides information that is any combination of being: unique to the manufactured item, unique to the batch of items that the manufactured item belongs to, and unique to the product.

16. The system of claim 10 wherein the multiple use verification code being hidden from view is by one of: being placed within an opaque container, and being hidden behind opaque tamper-evident material.

17. The system of claim 10 wherein exposure of the multiple use verification code is one of: after purchase, after taking possession, before use, and before consumption.

18. The system of claim 10 wherein receiving the multiple use verification code for validation is through one of: a website, an automated phone system, an interactive voice-response system, a phone conversation with a person, transmission of a photographic image, and electronic data exchange.

19. A method for providing product safety to a manufactured item comprising:
supplying the manufactured item with a verification code, wherein
the verification code is initialized to a first state, is hidden from view, and is exposed by a user for submission to a validation service a plurality of times;
in response to the validation service receiving the verification code for validation, providing the user with an indicator of a current state of the verification code; and
using a first successful validation of the verification code as an event that triggers a state transition of the verification code from the first state to a second state.

20. The method of claim 19 wherein the first state of the verification code is transitioned to a third state after one of: a period of time from being initialized to the first state, a period of time up to a fixed time, and on discovery of a problem.

21. The method of claim 19 wherein the second state of the verification code is further transitioned to a third state after one of: a period of time from entry into the second state, a period of time up to a fixed time, a fixed number of validations, and on discovery of a problem.
